(19) United States
(12) Patent Application Publication
(10) Pub. No.: US 2004/0046692 A1
(43) Pub. Date: Mar. 11, 2004

(54) Physical training system

(76) Inventors: Jack D. Robson, Bend, OR (US); Brian S. Higgins, Bend, OR (US); Brian A. Wetter, Bend, OR (US); John R. Cullen, Bend, OR (US); Chris Eckert, Bend, OR (US); Cynthia Homan, Bend, OR (US); Aaron Gifford, Bend, OR (US); Lucas Freeman, Bend, OR (US)

Correspondence Address: Kevin L. Russell, Chernoff, Vilhauer, McClung & Stenzel, LLP, 1600 ODS Tower, 601 S.W. Second Avenue, Portland, OR, 97204-3157, US

(21) Appl. No.: 10/236,334

(22) Filed: Sep. 5, 2002

(51) Int. Cl. G01S 5/14; A63B 71/00; G21C 17/00

(52) U.S. Cl. 342/357.06; 702/182; 340/573.4; 482/8

(57) ABSTRACT

A physical training system that includes a global positioning system.

### BACKGROUND OF THE INVENTION

The present invention relates to a physical training system.

People planning a hike, a climb, a bike ride, or otherwise traveling typically search through guide books to locate a suitable adventure. For example, Joe may be relatively out of shape and only capable of a relatively easy hike. Accordingly, Joe may search through his many guide books for a hike in the Columbia Gorge in Oregon having an estimated duration of less than one hour with an elevation gain of less than 500 feet. In contrast, Kevin being a fitness fanatic may search through his many guide books for a strenuous hike in the Columbia Gorge in Oregon having an estimated duration of more than 7 hours with an elevation gain of more than 8,000 feet. For both Joe and Kevin, searching through a stack of guide books for an appropriate hike is a tedious process where the estimated duration and strenuous nature of the hike is merely a rough estimate based upon some arbitrary criteria, typically the authors impression of the hike. The resulting exercise that either Joe or Kevin would expect to receive is merely estimated by the terse description available in the guide book. Further, after completing the hike Joe or Kevin would likewise be only able to estimate the aerobic results in some crude manner based on the actual elapsed time, elevation gain/loss indicated in the guide book, and estimated length in the guide book.

People planning a hike or a climb that does not follow a designated trail tend to plan their adventure using a combination of guide books and topology maps. During the travel such people also tend to carry a handheld global positioning device, such as those available from Magellan and Garmin, to help navigate. In addition, the handheld global positioning device may also be used in the event of getting lost in combination with a topology map (or internal map within the global positioning device) to locate ones position or otherwise to help navigate to a known location, such as a designated trail.

A global positioning system (GPS) typically works by triangulation of its current position from satellites. To triangulate the current position the GPS receiver measures distance using the time travel of radio signals. Typically some timing and error corrections are performed on the received signals to further refine the measurement. The result of the measurement includes ones position, which may be expressed by one or more of longitude, latitude, and elevation.

Currently available handheld global positioning devices track the longitude and latitude (or otherwise the persons location in some manner) of the person as they travel. This is normally presented to the user in the form of textual data or in a graphical format. Also, positioning data may be included within the global positioning device so that the user may navigate based upon the data, such as traveling from a first point to a second point. In addition, the global positioning devices may also include a compass, a trip odometer, maximum speed, current speed, moving average speed, overall average speed, etc. One example of such a device is the eTrek Venture, as explained in its owner's manual and reference guide, incorporated by reference herein. Accordingly, the handheld global positioning devices are used as navigational aids, which is their intended purpose.

### BRIEF DESCRIPTION OF THE DRAWINGS

FIG. 1 illustrates a global position device and data.

FIG. 2 illustrates a technique to specify an activity.

FIG. 3 illustrates a set of position vectors.

FIG. 4 illustrates an output display.

FIG. 5 illustrates a global position device and computer system.

FIG. 6 illustrates a graph of work out rate versus grade.

FIG. 7 illustrates a graph of speed versus grade.

FIG. 8 illustrates a rate of accent rate versus grade.

FIG. 9 illustrates calories burned.

FIG. 10 illustrates trek work.

FIG. 11 illustrates a map with a trek overlaid thereon.

FIG. 12 illustrates a topology may with a trek overlaid thereon.

### DETAILED DESCRIPTION OF THE PREFERRED EMBODIMENT

One current technique to characterize the physical activity of a person is to measure the breathing rate and oxygen concentration of the person while exhaling. Because of the required equipment for such measurements this is typically done in a laboratory setting on a treadmill. This technique provides accurate information regarding the chemical energy expended but typically requires complicated measurement techniques using a large breathing apparatus.

Another current technique to characterize physical activity of a person is to measure the torque at the petals of a bicycle. This provides an indication of the power delivered by the legs to the bicycle which is helpful for training purposes. However, such torque measurement devices are relatively expensive and limited to one sport, namely, biking.

Yet another technique to characterize physical activity of a person is to measure the heart rate of the body as an indication of the training level. By exercising within a specified heart rate range more targeted training may be achieved. However, heart rate monitors tend to indicate what the personal already knows, if he is “sucking air” then he is probably exercising to hard and if he is “not sucking air” then he should probably be exercising harder. However, simply monitoring the current heart rate indicates little, if anything, about the person's training progress over time.

A further technique to characterize physical activity of a person is to measure the distance and the elapsed time that the person traveled. On a flat surface, such as a oval track, together with a constant speed, then a reasonably accurate indication of the physical activity of the person may be determined. In addition, with a known profile of uneven terrain, such as a specific road, a reasonably accurate indication of the physical activity of the person may likewise be determined because it is the same every time.

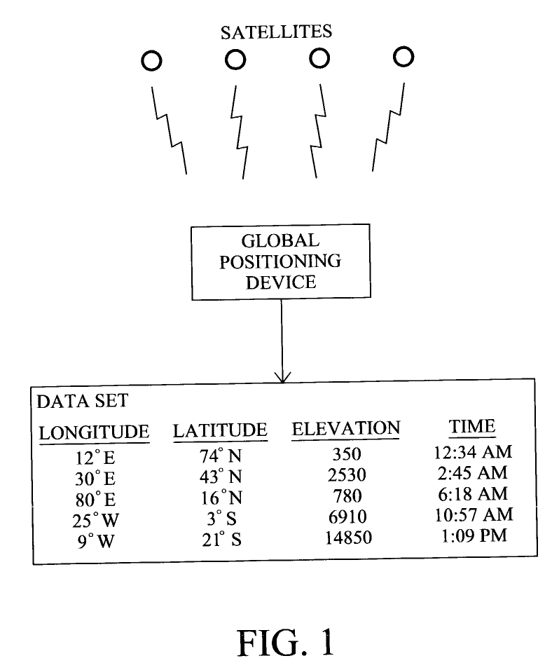

The present inventors considered currently accepted techniques for characterizing physical (e.g., cardiovascular) activity and came to the realization that by extending the previously accepted applications for global positioning devices physical activity may be measured for a significant range of activities. Referring to FIG. 1, one or more satellites 10 provides signal(s) to a global positioning device 12. The global positioning device 12 may be a non-handheld device (e.g., large heavy device, mounted to a vehicle, mounted to a bicycle, integrated within other electronics, etc.) though the GPS is preferably suitably sized for holding within the palm of the hand of the user, incorporated in a phone, incorporated in a watch, incorporated in a radio, etc. During activity of the user the GPS device 12 may obtain a set of position based information. The position based information may include, for example, latitude and longitude of the user, or relative displacements of the user based upon a previous measurement or position. In any event, the position based information provides data indicating the location of the user in some manner. The GPS device 12 normally measures the position of the user at different times which provides an indication of the current position of the user and data indicating the previous position(s) of the user, as illustrated in data set 14.

The position based information may further include respective time based information associated with the respective position based information. The time based information, may be for example, “wall clock” time (e.g., 12:34.23 pm, 12:34:23 am, or 20:23.23), or relative elapsed time based upon a previous time, or relative elapsed time from a previous position. In any event, the time based information provides an indication of the temporal based movement of the user in some manner.

The position based information may further include elevation based information associated with the respective position based information. The elevation information, may be for example, altitude relative to sea level (e.g., 1000 feet, 1000 meters, 29.67 mbars) or relative elevation information based upon a previous elevation, or relative elevation from a previous time or position. In any event, the elevation based information provides an indication of the elevation based movement of the user in some manner.

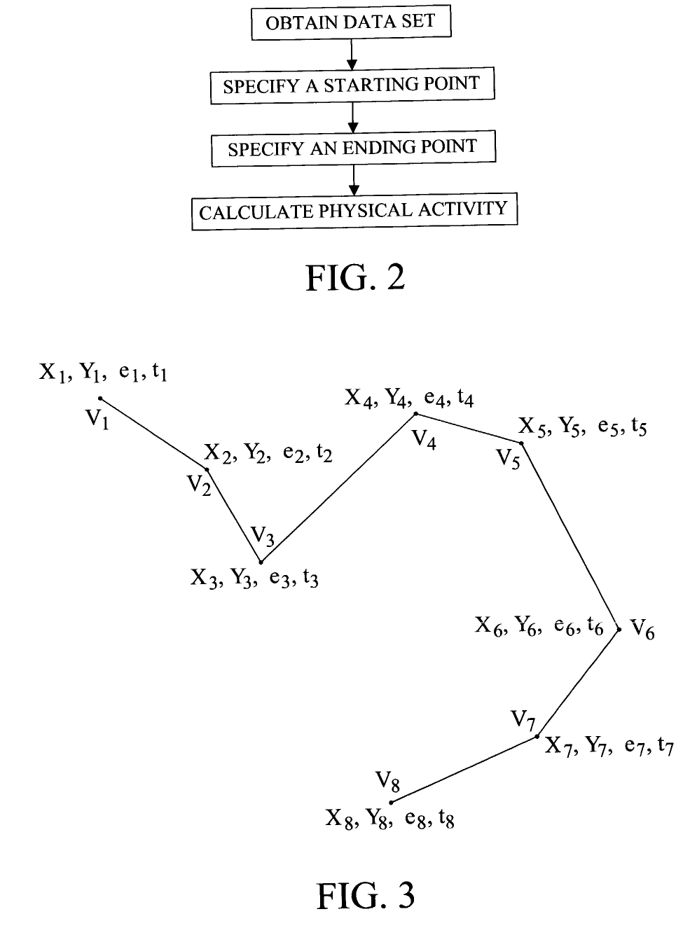

Referring to FIG. 2, with multiple different sets of position based information (e.g., at least two different positions) the handheld global positioning device may calculate physical activity based information for the user, such as calories burned. The user may select a starting position within the data set or otherwise the system selects a starting position. The user may also select an ending position within the data set or otherwise the system selects an ending position. The positioning device may then calculate the physical activity of the user based upon all or a portion of the data between the starting position and ending position (e.g., temporal based or otherwise).

Referring to FIG. 3, a change in position may be measured in a variety of ways, such as for example, those ways illustrated below.

The longitude and latitude positions (or relative displacements, etc.) may be used to determine the distance that the user traveled between the starting position and the ending position. The distance may be calculated as a summation of the vectors V1, V2, V3, V4, V5, V6, and V7 between subsequent data points using the x (longitude) and y (latitude) information. This calculation is particularly suitable when the terrain is generally flat.

A distance measurement may be calculated as a summation of the vectors V1, V2, V3, V4, V5, V6, and V7 (or e.g., V1, V2, V4, V5, and V7) between the subsequent data points using the e (elevation) information. This calculation is particularly suitable when the terrain is generally vertical such mountain or rock climbing.

A distance measurement may be calculated as a summation of the vectors V1, V2, V3, V4, V6, and V7 between the subsequent data points using the x, y, and e (elevation) information. This calculation is particularly suitable when the terrain is varied, such as hiking a along forest trail or running through the hills.

The GPS device or a separate device worn by the user may monitor the user's heart rate. The heart rate monitor may be used by itself or otherwise in conduction with the GPS or other device capable of receiving signals from the heart rate monitor. The data from the heart rate monitor is stored in the GPS device or otherwise the computer system.

A temporal based measurement may be calculated using the time information together with any of the previous calculations, as desired. For example, the time information for particular segments (Vx), or the elapsed time between the starting and ending positions, may provide further indications of physical activity, such as for example, relatively fast movement between points may be a higher cardiovascular workout than relatively slower movement between points. The cardiovascular activity (e.g., physical) information may take any suitable format, such as for example, difficult, easy, hard, medium, strenuous, calories burned, or stories climbed.

It is to be understood that the data may be obtained by any suitable device. For example, a Garmin handheld GPS device may be used, and a Suunto Watch and strap (includes a heart rate monitor).

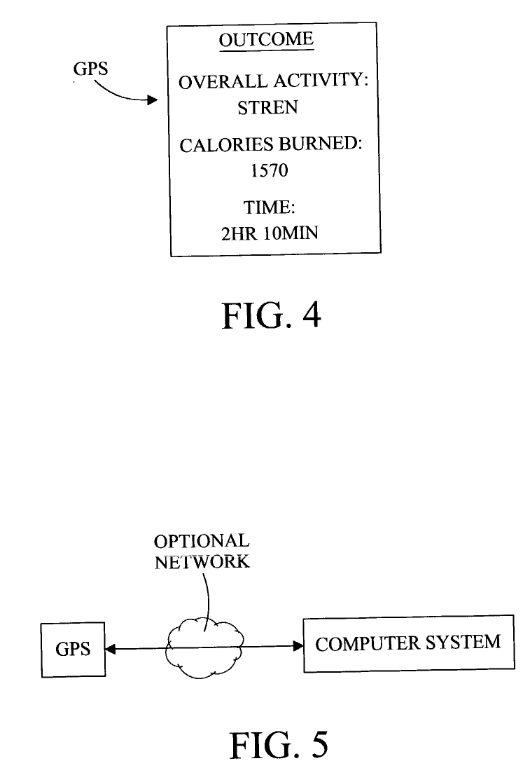

The calculations to determine cardiovascular activity (or otherwise) may be performed by the GPS device itself. In this manner, the user may determine his cardiovascular (or otherwise) activity readily using the device. This provides nearly immediate feedback regarding the activity that was recently undertaken. In addition, the system may provide feedback regarding the current level of physical activity on an ongoing or periodic basis based on all or part of the data. This avoids the necessity of using pencil and paper to perform the calculations. The device may present the results of the calculations to the user in any suitable manner, such as that illustrated in FIG. 4.

While monitoring the user's movement with a handheld global positioning device provides significantly enhanced benefits, especially for the monitoring of physical activity, it is still limited in the potential benefits that may be provided to the user. After considering the somewhat limited nature of a self-contained handheld global positioning device, the present inventors determined that providing network based capability for the physical activity monitoring significantly enhances its capabilities. Referring to FIG. 5, the GPS device may be interconnected to a computer system so that the data from the global positioning device may be transferred to the computer system. The computer system may be any type of computing device, such as a laptop, desktop computer, network server, either connected to the GPS device directly (wired or wireless) or through a network (wired or wireless).

A virtual race may be undertaken using the system, where the racers start and end at different times. Normally the elapsed time can be determined by using a stopwatch, it is difficult to measure the relative position of the racers during the race with them being run at different times. The GPS data may be used to measure the relative position with an associated temporal offset of the user during the race. For example a plot of the data of one racer relative to another racer may be performed with indications of the speed or relative time difference at different points in the race. In this manner, the users may determine that one racer while moving faster on the downhill portions lost significant relative time to the other racer on the up hill portions. The data may likewise be overlaid on maps, if desired. In addition, the data may be adjusted to reflect environmental factors, such as wind, rain, time, temperature, etc.

The computer system may receive data from previous activities (either as a group or data on an on-going basis if continuously interconnected to the computer system). The computer system then processes the data to provide information regarding the physical activity. The processed or unprocessed data may be maintained by the computer system, transferred to the GPS device, or otherwise made available to the user.

The computer system (or the handheld GPS device) may maintain a historical database of separate user activities. The historical database may then be used to track the user's training activities. For example, the historical database may be used as the basis to determine the change (increase or decrease) in the user's physical activity, cardiovascular ability, etc. In addition, the database may be used by the user to select an appropriate activity based on some criteria contained within the database.

### Trail Database

Normally the selection of an appropriate trail or path involves sifting through a myriad of guide books which provides some selective criteria based upon the authors impression. While of some value, it is still limited to the authors impression of the activity and provides somewhat limited information, such as a few paragraphs of directions and path information. In some instances, the user also has access to a relevant topology map which provides some additional information.

To enhance the user's ability to accurately select an appropriate activity, the present inventors determined that a database of path data from one or more users as a result of their downloading the data to the computer system is useful. The enhanced database enables user's to select from among a greater variety of potential activities. In addition, the data regarding a particular activity may provide additional insight into the strenuousness of the activity for the particular user. For example, the user may desire to select an activity in the Columbia George, Oregon that is about 2 hours long that burns approximately 3000-4000 calories. By searching the database the user may be able to locate such an activity. Furthermore, because the same activity may be previously undertaken by multiple users, the database may be able to provide more accurate information regarding the activity by providing both sets of data, or otherwise merging the data into a single data set, both of which provide much more than merely an author's subjective opinion of an activity. Preferably, the same path (e.g., trail, climb, etc.) are labeled or otherwise indicated as being the same.

Handicapping of the activity may likewise be performed. Based upon historical data a handicap may be determined for a particular user. For a particular race the handicap may be applied to even out the results. The handicap may be derived from, for example, the course distance, overall elevation, elevation gain, elevation loss, type of activity, type of terrain, type of road, type of trail, trail rating, etc. In addition, the resulting database of information may be used in the GPS device to travel along someone else's trek. The GPS device may include the ability to follow a previous set of points and indicate that you are off track if you vary from the downloaded path.

The database may be further annotated with characteristics of the activity, such as for example, single track, dual track, rocky road, smooth road, windy trail, altitude, etc. Further, the items in the database may include an address, such as for example, a city, a state, a zip code, a country, latitude, and/or longitude. To make searching for particular activities more straightforward, search words may further be included.

For some trail activities, different user's may go slightly different distances. For example, one user may hike 5 miles down the trail before returning while another user may hike 5.2 miles down the trail before returning. Accordingly, the data from the two different user's will be slightly different, namely, the additional 0.2 miles (0.4 round trip). The computer system, or an operator of the computer system, preferably modifies one or both of the data sets to make the path of travel more consistent than the original data. In this manner, physical information that is determined based upon the modified path is more consistent with the other data, which itself may have been modified.

For many potential trails the user may have a map and guidebook information, but typically along the hike the user has no particular information regarding his exact position. For example, the user may know that he passed the waterfall 1 hour ago and that the fork in the trail is somewhere approximately 7 miles past the waterfall. With the GPS device the user has the ability to know his position, which may then be located on a topology map to provide an indication of his position relative to other landmarks. While beneficial, the user still remains unsure how long it should take to get to the fork in the trail, which may involve traversing a rocky hillside on a marginal trail and an additional 5000 feet of elevation gain.

The present inventors considered the current limitations and came to the realization that by downloading a previous data set(s) from the computer system to the GPS device regarding another user(s) who previously traveled the same path, the current user may obtain a far more accurate estimate of the time remaining, calories to be burned, elevational gain remaining, etc. The data (or path information) may be overlaid on a topology map contained within the GPS device to provide additional information. Such information is especially useful when the path traveled includes a significant amount of cross-country travel away from designated trails.

Another set of features that may be included is a personal profile of the particular user who obtained the data or otherwise is using the GPS device. The personal profile may include, for example, his age, weight, height, gear weight, etc. The gear weight affects calories burned which is reflected in accurate chloric calibration. This permits, if desired, the analysis of the data to be modified in such a manner that it is specific to the particular user. For example, the analysis of the physical activity of the user for a particular activity may be based upon his personal profile and/or performance during previous activities. In addition, while searching through other activities in the database, the data may be recalculated to provide physical activity that is particularized for the particular user. For example, the data from a marathon runner averaging 5:30 miles for a particular run that took 45 minutes may be recalculated for the new user to indicate a new anticipated average time per mile together with an overall anticipated time to complete of 2 hours. In this manner, the data may be adjusted to reflect a more realistic performance.

Another benefit of the trail database provides accurate distance measurements of particular activities together with an accurate mapping of the activity that includes actual elevation measurements. In addition, the system may likewise determine, with reasonable accuracy, the total elevation gain, elevation loss, and net elevation loss/gain.

With the benefit of developing accurate trail information together with accurate elevation information, this data may be used as the basis of the development of trail/activity guides and maps. This results in revised guides and maps with more accuracy.

Another feature that may be used is the replaying of a trek in two-dimensions or three-dimensions if altitude information is available. In this manner, the user can observe in some manner his performance during the activity. For example, the replay can indicate the slowness of the user when traveling up a steep hill and the fastness of the user when traveling down a relatively steep hill together with transition information.

It is further noted that in some instances the existing database, or other available databases, will have elevation information for a given position (e.g., latitude and longitude). In such case it may not be necessary to obtain the altitude information from the user.

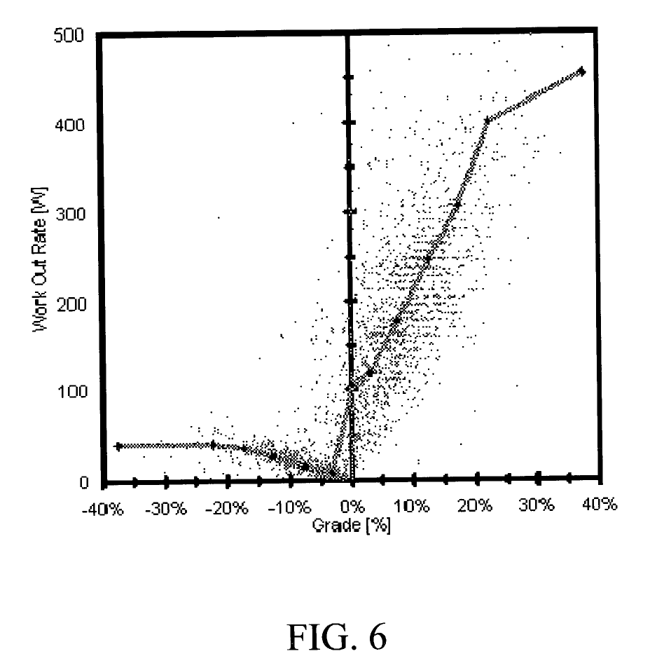

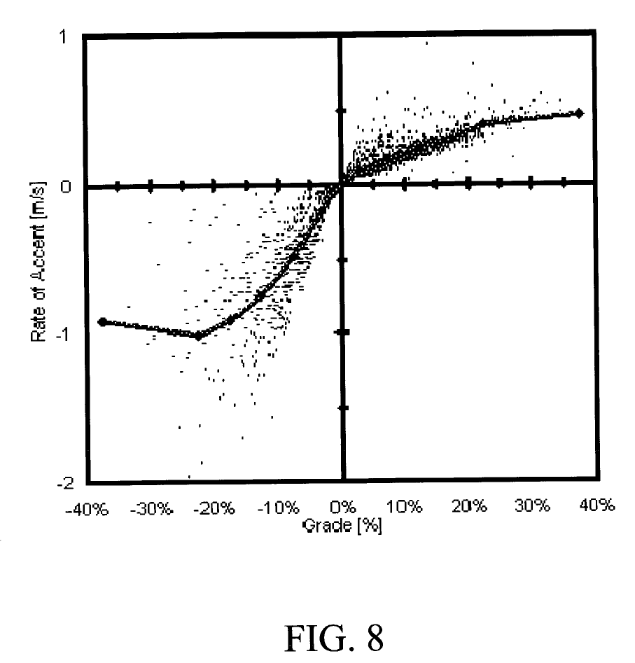

To provide an example of how a limited implementation of the system may operate the following information is provided. Referring to FIGS. 6, 7, and 8 a plot of the work out rate versus grade, speed versus grade, and rate of accent versus grade. Any one of the three and others may be used to handicap a ride. Elevation change (grade) is the primary ingredient for handicapping a ride or a hike.

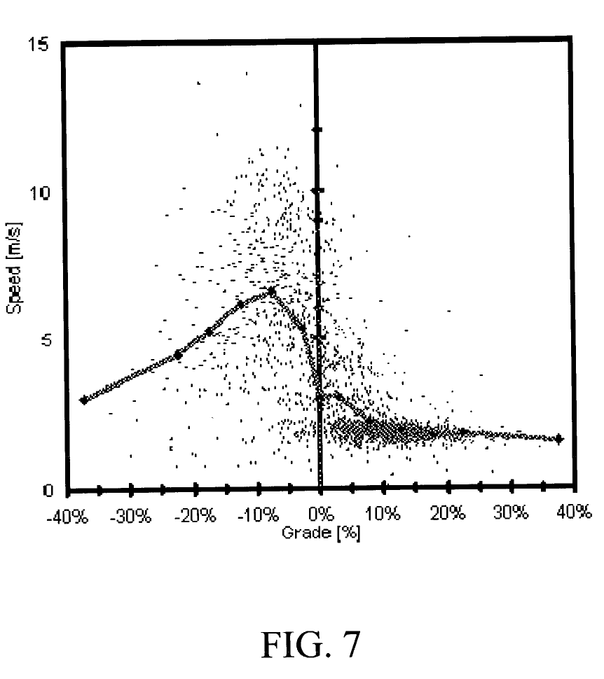

Referring specifically to FIG. 7 the process may be as follows (with focus on mountain biking, but it works for other activities as well):

1) Someone goes on a ride; and the system does its analysis.

(a) Between each two GPS points during their ride, the system may calculate speed and grade, hence the scatter plot.

(b) The system may then calculate a histogram (the thick line) based on the entire ride (or the system could do a correlation).

(c) This represents what the system thinks they can do for any ride.

2) Note that at this point the system is able to use the histogram information to calculate the time it would take them to go between any two points on a different trail.

3) Next, the system may come up with a “professional biker” histogram. i.e. data derived from a real professional (or other) biker.

4) To handicap a particular trail:

(a) The system predicts our client's time by using the velocity versus grade histogram to calculate the time step between every two GPS points. The sum of this time is the estimated time to complete the trail.

(b) The system predicts the “professional biker” to find the “professional biker's estimated time to complete the trail.

(c) The user's handicap is equal to their time minus the pro's time, all divided by the number of miles in the trail. That is, the handicap is the number of seconds per mile you get subtracted from your final time if you are racing a handicap race against the pro.

5) Note the following:

(a) A client has a different handicap for every trail (which will indicate if the trail is good for their style of riding or not).

(b) A client has a different histogram for every ride they've done. Typically handicaps are calculated based on an average of the last five or ten rides.

(c) The system may make this more complex as desired by the customer base. For example, the system could further categorize based on how long a client has been riding. If they went up a 10% grade at 3 m/s during the first half hour of a ride, they might only be able to go up a 10% grade at 2.5 m/s during the fourth hour of a ride. This can be taken into account.

One added benefit is that once the system has someone's histogram figured out, the system may use it to determine their riding characteristics for any trail: The system uses the velocity versus grade histogram to calculate the time step between every two GPS points. Then the system may port this into the analysis code to give a predicted workout rate and energy expenditure for a given ride. The system could very accurately predict how long it would take a typical client to ride on a particular trail, even if they've never been on it.

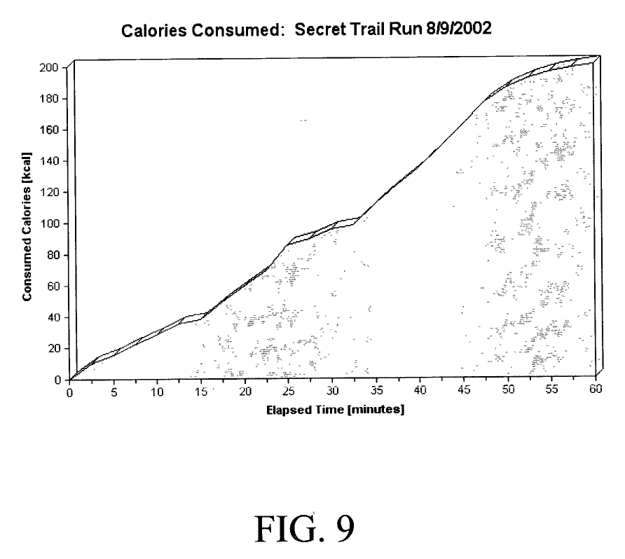

Referring to FIG. 9, a simple chart of the number of calories consumed over time during a particular athletic endeavor is shown. If multiple endeavors (treks) had been selected, those may appear as a comparison in the same graph.

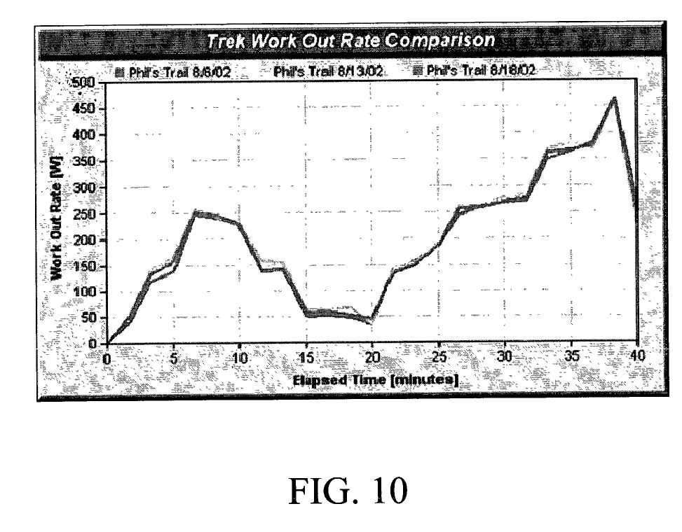

Referring to FIG. 10, the graph depicts three similar activities performed at different times. This graph specifically demonstrates the workout rate (expressed in terms of watts). Because the workout was quite similar (in this case a bike ride over the same trail), the comparisons show many similarities.

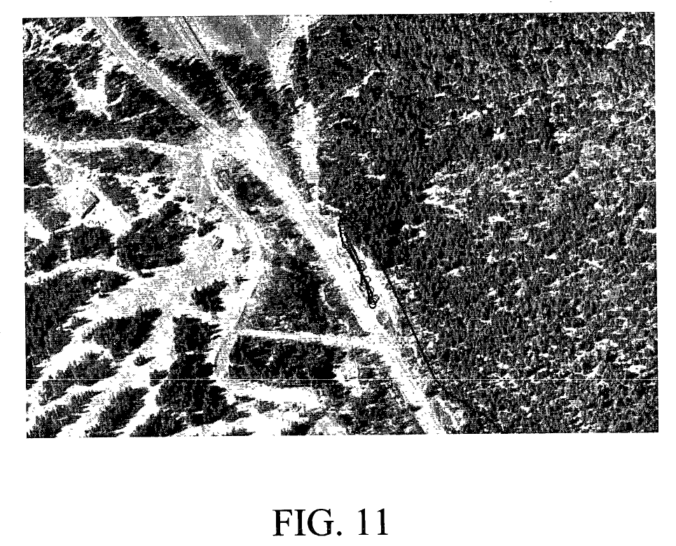

Referring to FIG. 11, the image may depict a trek or ride data overlaid on top of an aerial photograph. The trek points in this image are selectable for the purposes of selecting the starting and ending points of a trek.

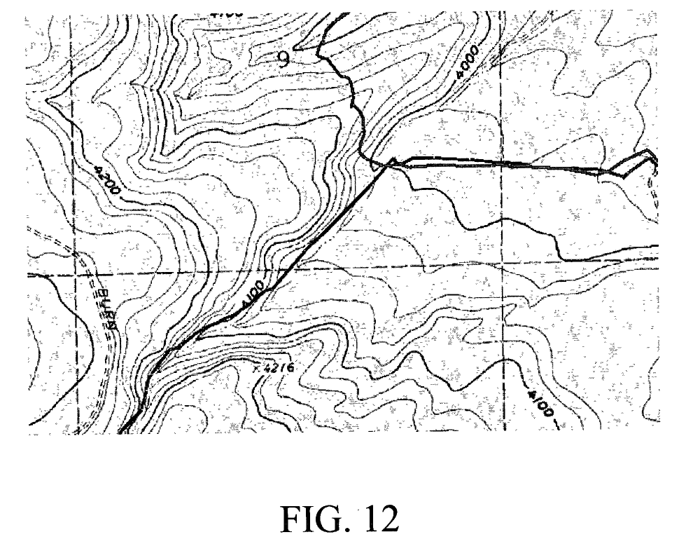

Referring to FIG. 12, the image may depict a ride comparison on a topographical map. The map type can be readily specified (aerial, topographical, or relief), as can the map scale and centering.

Algorithm (Data analysis)

Main Function( )

Call Get_Preferences (subroutine)

Call Get_Data (subroutine)

Convert latitude and longitude to meters.

This section determines the distance between two points.

Specifically, the system looks for the associated change in x and y distances.

However, the globe is a sphere and x and y are in Cartesian coordinates.

Determine section breaks

There are two types of section breaks

(1) The GPS system puts in breaks when satellites are lost or GPS is turned off and on.

(2) We put in additional section breaks when the workout stops for a period of time.

Smooth data by section

All of the data is looped through, taking four point sections.

Each four points are used to smooth the date between points 2 and 3.

Call b_spline( )

If there are only two points, then fictitious points are created (mathematically equal to a line between points 2 and 3, i.e., no smoothing)

Once the data is smoothed gradients are calculated

(the gradient of position is velocity)

(the gradient of velocity is accleration)

(the gradient of altitude is rate of accent)

Once gradients are calculated the following are calculated:

distance traveled

speed

direction (compass degrees)

acceleration in direction traveled

grade

Then energy calculations are performed

Potential_Calc

Kinetic_Calc

Friction_Calc

Aero_Calc

Walk_Calc

Run_Calc

Total power is the sum of above

If total power for unit is positive, then effort is required (positive power).

If total power for unit is negative, then effort is required (negative power)

Since power is the rate of change (gradient) of energy expended, it often needs to be smoothed. This is done next.

Call Metrics (Metrics are Calculated)

Subroutines

b_spline( )

Purpose: Given four data points with (x) and (y) values, this subroutine smoothly interpolates between them using a b-spline. This is done four times with time, longitude, latitude, and altitude.

Potential_Calc( )

Purpose: Calculate the potential energy required.

Equations: Force=m*g

Energy(work)=force*h

Inputs: m=mass [lbs]

dz=altitude gain [m]

dx=horizontal distance traveled [m]

Outputs: energy/work required [J]

Limit potential energy

Potential_Calc=m*lbs_to_kg*gc*tempz

Kinetic_Calc( )

Purpose: Calculate the ma term in F=ma; due to kinetic energy changes.

Equations: Force=m*a

Energy(work)=force * distance

Inputs: m=mass [lbs]

Accel=Acceleration term [m/s2]

dx=horizontal distance traveled [m]

Outputs: energy/work required [J]

Kinetic Calc=dx*m*lbs_to_kg*tempa

Friction_Calc( )

Purpose: Calculate the energy required to overcome friction.

Equations: Force=Crr*m*g*cos(angle)

Energy(work)=force*distance

Inputs: m=mass [lbs]

Crr=coeffiecent of rolling resistance [ ]

dz=altitude gain [m]

dx=horizontal distance traveled [m]

Outputs: energy/work required [J]

Friction_Calc=dx*Crr*m*lbs_to_kg*gc*Cos(Atn(dz/dx))

Aero_Calc( )

Purpose: Calculate the energy required to overcome aerodynamic drag.

Equations: Force=0.5*Cd*A*rho*V\hat{ }2

Energy(work)=force*distance

Inputs: Cd=coeffiecent of rolling resistance [ ]

Spd=speed [m/s]

Frontal_Area=projected frontal area [m2]

Density=density of air [kg/m3]

dx=horizontal distance traveled [m]

Outputs: energy/work required [J]

Aero_Calc=dx*0.5*Cd*Frontal_Area*Density*Spd*Spd

Walk_Calc( )

Purpose: Calculate the energy required to walk.

Equations: Force=V\hat{ }2*500/4/1000*m*dt

Force=V\hat{ }2*500/4/1000*m*(dx/V)

Force=V/8*m*dx

Energy(work)=force*distance

Inputs: m=mass [lbs]

Spd=speed [m/s]

dx=horizontal distance traveled [m]

Outputs: energy/work required [J]

Walk_Calc=Spd/8*m*lbs_to_kg*dx\hat{ }2

Run_Calc( )

Purpose: Calculate the energy required to run.

Equations: Force=V/4/1000*m*dt

Force=V*500/4/1000*m*(dx/V)

Force=1/4000*m*dx

Energy(work)=force*distance

Inputs: m=mass [lbs]

Spd=speed [m/s]

dx=horizontal distance traveled [m]

Outputs: energy/work required [J]

Run_Calc=1/4000*m*lbs_to_kg*dx\hat{ }2

Get_Preferences( )

Reads in preferences (user settings)

Variables include:

Sex, Height, Age, Mass (Weight), Activity (bike, run, etc)

Crr (rolling friction)

Cd (aerodynamic drag)

Frontal_Area

Mech_Pos (mechanical efficiency with power out)

Mech_Neg (mechanical efficiency with power in (going down hill))

Mass_Gear (e.g., bike or backpack)

Density (of air)

User settable smoothing variables:

VelocityStoppedThreshold, TimeStoppedThreshold, UpRateThreshold, DnRateThreshold, SpeedThreshold, AccelerationThreshold, TimeResolution, PowerWeightAve, PowerIterations, PowerBlockMin, PowerBlockMax, Override, GradeFlatCriterion, PowerStoppedCriterion, IncludeGlitch, WeightLossGoal, Hill_Up_Grade, Hill_Up Distance, Lc_Threshold,

Get_Data( )

Read in data from GPS transfer manager

Gradient( )

Determine gradients using a differentiated second-order Lagrange interpolating polynomial

Function Metrics( )

Calculate metrics

Latitude and Longitude

Latitude(i), Longitude(i)

LatitudeStart, LatitudeStop, LatitudeAve

LongitudeStart, LongitudeStop, LongitudeAve

Time

TimeOverall, imeEvent, TimeGlitch

TimeUp, TimeDn, TimeFlat, TimeStopped

TimeUpPerc, TimeDnPerc, TimeFlatPerc, TimeStoppedPerc

TimeRest, TimePropulsion, TimeBrake,

TimeRestPerc, TimePropulsionPerc, TimeBrakePerc

Distance and Velocity

DistanceEvent

DistanceUp, DistanceDn, DistanceFlat, DistanceStopped, DistanceGlitch

DistanceRest, DistancePropulsion, DistanceBrake

VelocityUp, VelocityDn, VelocityFlat

VelocityRest, VelocityPropulsion, VelocityBrake

Altitude and Grade

AltitudeNet, AltitudeUpNet, AltitudeDnNet

AltitudeUp, AltitudeDn, AltitudeFlat, AltitudeStopped

AltitudeRest, AltitudePropulsion, AltitudeBrake

AccentUp, AccentDn, AccentFlat

AccentRest, AccentPropulsion, AccentBrake

GradeUp, GradeDn, GradeFlat

GradeRest, GradePropulsion, GradeBrake

Energy and Power

EnergyEvent-BrakeEvent

EnergyLightBeer, EnergyDarkBeer, EnergyChocolate, EnergyRamen

EnergyWeight, EnergyWeightPerc, EnergyReqGoal

EnergyUp, EnergyDn, EnergyFlat, EnergyStopped

EnergyRest, EnergyPropulsion, EnergyBrake

PowerUp, PowerDn, PowerFlat

PowerRest, PowerPropulsion, PowerBrake

Energy modes

EnergyEvent, EnergyPotential, EnergyKinetic

EnergyFriction, EnergyAero, EnergyWalking, EnergyRunning

Braking modes

BrakeEvent

BrakePotential, BrakeKinetic, BrakeFriction

BrakeAero, BrakeWalking, BrakeRunning

METS and Activity Factor

SedDay, SedEvent, SedWorkout

METS_Day, METS_Event, METS_Workout

ActivityFactor

Grade Analysis

GrTime(j), GrAltitude(j), GrDistance(j), GrEnergy(j)

GrPower(j), GrMETS(j), GrAccent(j), GrSpeed(j)

StTime, StAltitude, StDistance, StEnergy

It is noted that the algorithms may modified in any manner, as desired.

What is claimed is:

1. A system for determining physical activity of a user comprising:
(a) a global positioning device suitable for being held in the hand of said user;
(b) said global positioning device obtaining at least a first position of said user and a second position of said user; and
(c) said global positioning device calculating said physical activity of said user.

2. The system of claim 1 wherein global positioning device determines said first position based upon data from at least one satellite.

3. The system of claim 1 wherein said first position includes a longitude measurement and a latitude measurement.

4. The system of claim 1 wherein said first position includes an elevation measurement.

5. The system of claim 4 wherein said first position further includes a longitude measurement and a latitude measurement.

6. The system of claim 3 wherein said global positioning device further obtains a first time associated with said first position.

7. The system of claim 5 wherein said global positioning device further obtains a first time associated with said first position.

8. The system of claim 1 wherein said physical activity includes calories burned.

9. The system of claim 1 wherein said global positioning device further obtains a first time associated with said first position.

10. A system for determining physical activity of a user comprising:
(a) a global positioning device suitable for being held in the hand of said user;
(b) said global positioning device obtaining a least a first position of said user and a second position of said user; and
(c) said global positioning device providing said first and second position to a separate computer system;
(d) said computer system calculating said physical activity of said user.

11. The system of claim 10 wherein said global positioning device further obtains a first time associated with said first position.

12. The system of claim 10 wherein global positioning device determines said first position based upon data from at least one satellite.

13. The system of claim 10 wherein said first position includes a longitude measurement and a latitude measurement.

14. The system of claim 10 wherein said first position includes an elevation measurement.

15. The system of claim 14 wherein said first position further includes a longitude measurement and a latitude measurement.

16. The system of claim 13 wherein said global positioning device further obtains a first time associated with said first position.

17. The system of claim 15 wherein said global positioning device further obtains a first time associated with said first position.

18. The system of claim 10 wherein said physical activity includes calories burned.

19. The system of claim 10 wherein said system further includes a heart rate monitor and said determining physical activity is further based upon said heart rate monitor.

20. A method for determining physical activity of a user comprising:
(a) obtaining at least a first position and a second position of said user using a global positioning device; and
(b) calculating said physical activity of said user based upon said first and second positions.

21 The method of claim 20 wherein said global positioning device is suitable for being held in the hand of said user.

22. The method of claim 20 wherein global positioning device determines said first position based upon data from at least one satellite.

23. The method of claim 20 wherein said first position includes a longitude measurement and a latitude measurement.

24. The method of claim 20 wherein said first position includes an elevation measurement.

25. The method of claim 24 wherein said first position further includes a longitude measurement and a latitude measurement.

26. The method of claim 23 wherein said global positioning device further obtains a first time associated with said first position.

27. The method of claim 25 wherein said global positioning device further obtains a first time associated with said first position.

28. The method of claim 20 wherein said physical activity includes calories burned.

29. The method of claim 20 further comprising calculating said physical activity on an on-going basis.

30. A method for creating a database of paths comprising:
(a) obtaining a plurality of positions of a user using a global positioning device for a plurality of different paths;
(b) storing each of said plurality of positions for said plurality of said different paths in a database; and
(c) searching said database for one of said different paths.

31. The method of claim 30 further comprising obtaining a plurality of positions of another user using another global positioning device for another plurality of different paths.

32. The method of claim 30 wherein said global positioning device is suitable for being held in the hand of said user.

33. The method of claim 31 wherein said another global positioning device is suitable for being held in the hand of said another user.

34. The method of claim 30 wherein said database is used as the basis for a guide book.

35. The method of claim 10 wherein said calculating includes heart rate data.

36. The method of claim 20 wherein said calculating includes heart rate data.
